(19) United States
(12) Patent Application Publication
(10) Pub. No.: US 2004/0235453 A1
(43) Pub. Date: Nov. 25, 2004

(54) Access point incorporating a function of monitoring illegal wireless communications

(76) Inventors: Chia-Hung Chen, Fremont, CA (US); Wheng Wang, Fremont, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/443,963

(22) Filed: May 23, 2003

(51) Int. Cl. H04M 1/66

(52) U.S. Cl. 455/410; 455/411

(57) ABSTRACT

An access point comprises a transceiver unit for normal access point function and a receiver unit to scan all channels for monitoring illegal wireless communications such as intruder and abnormal traffic. A buffer is provided in the access point to store the scanned packets from the monitoring receiver unit for an algorithm to screen the scanned packets under a user-defined configuration. The access point will automatically notify the user of the detected illegal wireless communications by blinking LED, buzzer, email alert or phone alert. The configuration includes identification of specific wireless devices and traffic or communication conditions and is updated to optimize the performance of the access point.

### FIELD OF THE INVENTION

The present invention relates generally to wireless communications, and more specifically to an access point (AP) capable of monitoring illegal wireless communications.

### BACKGROUND OF THE INVENTION

Wireless communications between separated electronic apparatus are widely used. For example, a wireless local area network (WLAN) is a flexible subsystem that may be an extension to, or an alternative for, a wired LAN within a building. Each type of wireless communication system is constructed, and hence operates, in accordance with one or more standards, for example IEEE 802.11, Bluetooth, advanced mobile phone services (AMPS), digital AMPS, global system for mobile communications (GSM), code division multiple access (CDMA), wireless application protocol (WAP), local multi-point distribution services (LMDS), multi-channel multi-point distribution systems (MMDS), and variations thereof. An IEEE 802.11 compliant wireless communication system includes a plurality of wireless communication devices, e.g., laptop, personal computer (PC), and personal digital assistant (PDA), coupled to a station and a plurality of access points. The access points are physically distributed within the wireless communication system to provide seamless wireless services throughout the system for its wireless communication devices. As is known, each access point utilizes one of a plurality of channels, i.e., frequencies, to communicate with affiliated stations, i.e., stations within the coverage area of the access point and registered with the access point. Such coverage area is generally referred to as a basic service set (BSS). To minimize interference between adjacent BSSs, access points use different channels. The use of differing channels forms a pattern of channel reuse, which is commonly referred to as a cell pattern.

However, IEEE 802.11 opens up a more interesting and dangerous possibility that an attacker could achieve unauthorized access to the network without physically connecting to the network. Parking-lot attacks are real and tangible threat to many people, and especially frightening because the attacker could do almost anything. It's the unknown and uncontrollable risk that frightens many security professionals. IEEE 802.11 further opens up a more interesting and far more dangerous possibility that a power user could simply bring an access point to work because they want the convenience of a wireless network, but can't be bothered with the IT department's delays in deployment. Being power users, they know that they can simply assign the access point an address via DHCP, plug their own wireless cards into their laptops, and then walk around the office with their laptops. With proxying and NAT software, this kind of activities might even go totally unnoticed by security personnel or automated intrusion detection systems. Little does this user know that the IT department's concerns are well founded, and the user has unwittingly opened a gaping hole in the local network, such that any drive-by attacker could simply hop on the local network and do anything they wish. As is also known, once a channel is set for an access point, there is no mechanism for the access point to receive any traffic from the other wireless devices on other channels. Therefore the access point could not detect the presence of any wireless devices operating on other channels. In addition to the unauthorized device or intruder, abnormal traffic may occur due to fault of device or linking, intentional interference or mass data delivery.

It is thus desired a mechanism incorporated in access point for monitoring and detecting any illegal wireless device and traffic present in the service area.

### SUMMARY OF THE INVENTION

Accordingly, one object of the present invention is to provide an access point incorporating a function of monitoring illegal wireless communications.

In an access point, according to the present invention, in addition to a transceiver unit for normal access point function, a receiver unit is further included to scan all channels for monitoring illegal wireless communications such as intruder and abnormal traffic. A buffer is provided in the access point to store the scanned packets from the monitoring receiver unit for an algorithm to screen the scanned packets under a user-defined configuration. The access point will automatically notify the user of the detected illegal wireless communications by blinking LED, buzzer, email alert or phone alert. The configuration includes identification of specific wireless devices and traffic or communication conditions and is updated to optimize the performance of the access point.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is an illustrative diagram to show a scheme according to the present invention;

FIG. 2 is a flowchart of alert employed in one embodiment of the present invention;

FIG. 3 is a flowchart to update the scanned wireless device information in one embodiment of the present invention;

FIG. 4 is a flowchart of alert to screen the scanned access points in one embodiment of the present invention;

FIG. 5 is a flowchart of alert to screen the scanned stations in one embodiment of the present invention;

FIG. 6 is a user interface to configure the access point for monitoring illegal communications;

FIG. 7 is a table for the user to set up the email accounts to receive email alerts;

FIG. 8 is a table for the user to set up the phone numbers to receive phone alerts;

FIG. 9 is a table to update the devices information;

FIG. 10 is a table to select the displayed device;

FIG. 11 is a collection of all devices information;

FIG. 12 is a table including all access points;

FIG. 13 is a table including all own access points;

FIG. 14 is a table including all nearby access points;

FIG. 15 is a table including all unknown access points;

FIG. 16 is a table including all stations;

FIG. 17 is a table including all own stations;

FIG. 18 is a table including all nearby stations; and

FIG. 19 is a table including all unknown stations.

### DETAILED DESCRIPTION OF THE INVENTION

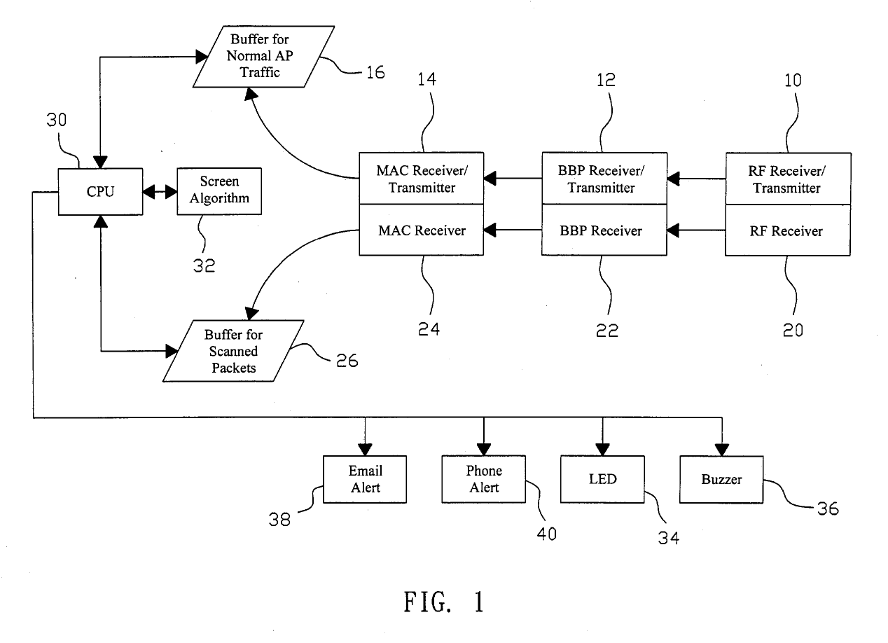

In an invented access point, as shown in FIG. 1, a transceiver unit including an RF transceiver 10, a baseband process (BBP) transceiver 12 and a medium access control (MAC) transceiver 14 performs a normal access point function, as in a conventional access point. A transceiver is a module combining a transmitter with a receiver, and is well known in the art. Also, in the access point, a buffer 16 is provided to store the packets for the normal access point traffic, which is a prior art. To monitor illegal wireless communications, according to the present invention, a receiver unit including an RF receiver 20, a baseband process receiver 22 and a MAC receiver 24 is further comprised in the access point to scan all channels. In the receiver unit, the RF receiver 20 transforms the received RF signal to a baseband signal, the baseband process receiver 22 transforms the baseband signal to a decoded signal, and the MAC receiver 24 extracts the packets from the decoded signal. The scanned packets from the receiver unit are stored in a second buffer 26 in advance and wait for being further screened by an algorithm to determine if any illegal device or traffic is scanned. As in a conventional access point, a central processing unit (CPU) 30 is provided to control the normal traffic. In addition, the CPU 30 also controls the process of the invented access point to monitor the illegal communications. In particular, the CPU 30 will screen the packets stored in the buffer 26 by following a screen algorithm 32 that is configured by user and dynamically updated. This manner the linked wireless devices on each channel are thus monitored. Once an illegal device or traffic is scanned, the access point will notify the user or a host connected to the access point of the illegal communications by a warning apparatus, such as LED lamp 34 and buzzer 36. A remote notification of the scanned illegal communications can be further provided by email alert 38 and/or phone alert 40. Those monitoring processes and notifications of illegal communications are controlled by the CPU 30. Alternatively, however, a control circuit or a software process (i.e., program approach) other than a CPU can be employed in the access point to take care of the monitoring function.

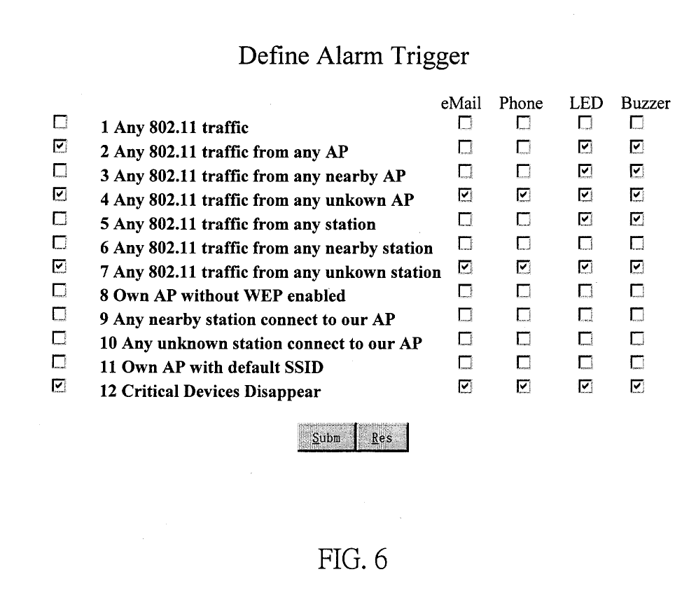

To optimize the system performance or adaptive to user's requirement, the access point is configured in advance to define what is illegal and when to issue a notification. In other words, the conditions to determine if a scanned wireless device or traffic is illegal are user-defined or programmable. Once the access point is configured, the algorithm 32 will screen each scanned wireless device or traffic based on the configuration. To configure the access point for monitoring illegal communications, a friendly user interface can be provided for example in FIG. 6, by which several conditions including various wireless devices and traffic and the way to alert are set up by selecting from the check boxes on the user interface. Generally, two types of illegal communications can be monitored. In particular, they are wireless devices and traffic on the monitored channels that may be harmful or abnormal to the communication system. For the former, unauthorized devices or intruders are picked up from the scanned channels for the supervisor to make early defense. On the other hand, even an authorized or legel device is detected, there is possible to have abnormal traffic, such as absent of effective WEP, violent data delivery and repeated useless queries. WEP is defined in IEEE 802.11 for security of wireless communications following IEEE 802.11. In general, a user is asked to incorporate a WEP key in the packets for his wireless communications. If the traffic is found without effective WEP, a warning can be issued to prompt to the supervisor or user. A violent data delivery may be induced by an intruder or an authorized user for illegal purposes or over his authorized access. The repeated useless queries are resulted from intentional attacks by an intruder or an authorized user or simply a linking fault or system fault between an authorized wireless device and the access point. Such traffic can be defined in the access point to be illegal and prompted to the supervisor for further security policy.

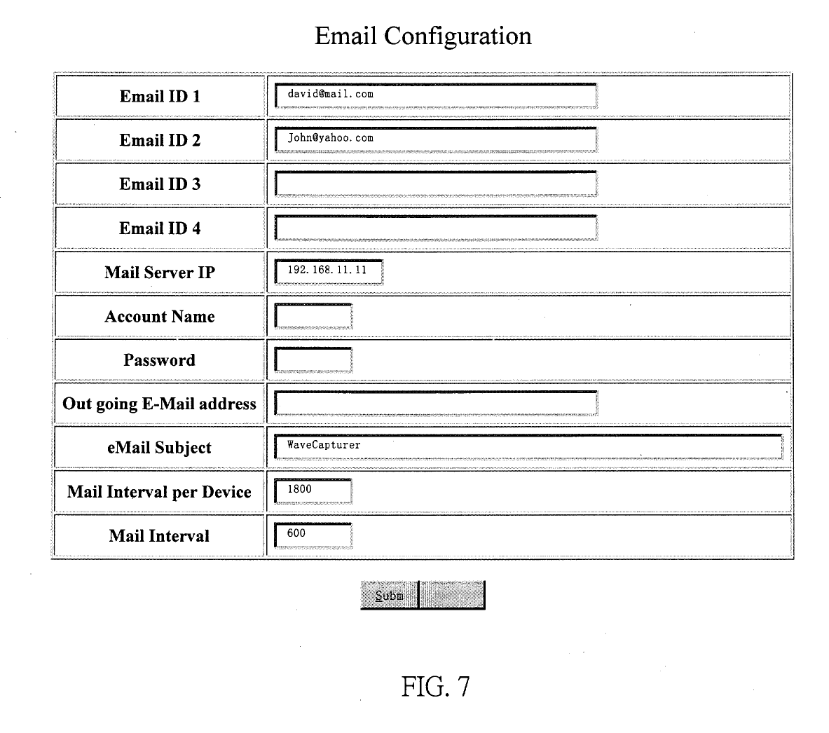

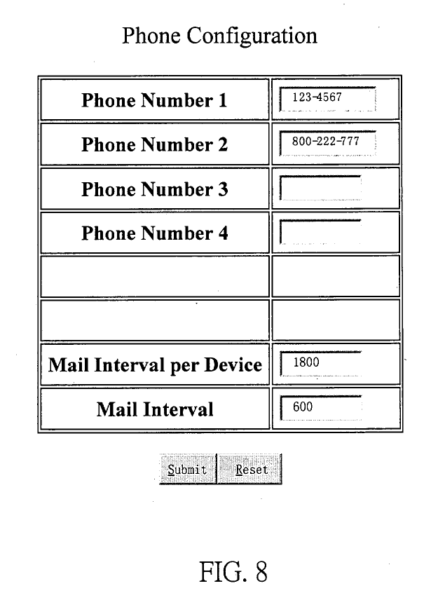

In addition to the notifications of illegal communications by blinking LED 34 and buzzer 36, a host for example a notebook PC or a hand-held computer could be connected to the access point by for example a PCMCIA card or other interfaces to receive the email alert and phone alert through the functional blocks 38 and 40 in FIG. 1. However, the access point can be linked to a LAN or Internet for the email alert or phone alert to reach more far away and more clients. Once an email alarm is triggered, the access point will automatically send the email alert to the remote user in a predetermined manner. Likewise, the access point will automatically send a phone mail to call the remote user if a phone alarm is triggered. FIG. 7 and FIG. 8 show setup tables for the user to configure the email accounts and phone numbers to receive the issued email alerts and phone alerts, respectively.

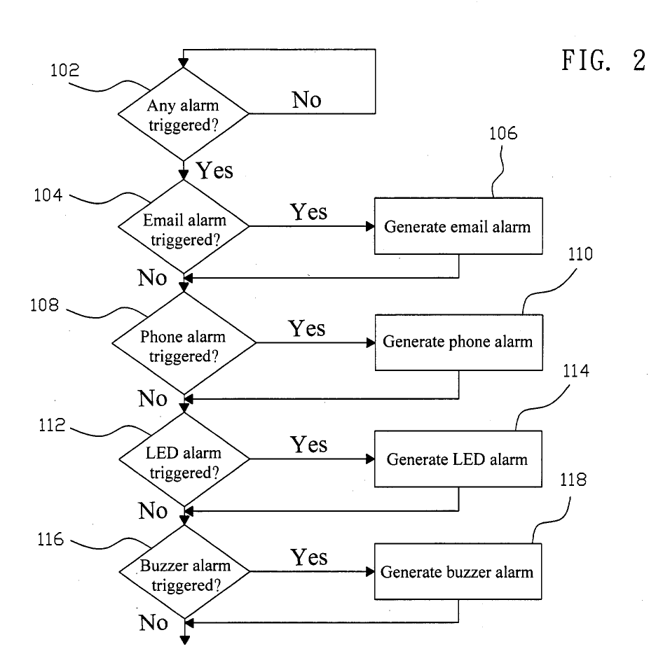

For alert to notify the user, a flowchart to generate various alarms is shown in FIG. 2. In step 102, it is determined if any alarm is triggered by the algorithm 32 of FIG. 1 to screen the scanned packets, i.e., if any condition is matched to the configuration of illegal communications for example in FIG. 6. If not matched, the status is kept on waiting. Contrarily, if any defined illegal condition is matched, a series of steps to generate various alarms are performed. In step 104, the configuration is checked to identify if an email alert is setup for the current illegal condition. If it is, then step 106 is performed to generate an email alarm; otherwise, next step 108 is performed to check if a phone alarm should be triggered. If it should be, the step 110 will generate a phone mail alarm; otherwise step 112 is performed to check if LED alarm is needed. If it is, step 114 will generate an LED alarm to blink the LED lamp 34 of the access point in FIG. 1; otherwise, step 116 is performed to check if buzzer alarm is preset up. If it is, step 118 will generate a buzzer alarm. When the alert flowchart is completed, the status returns to wait for another alarm triggered.

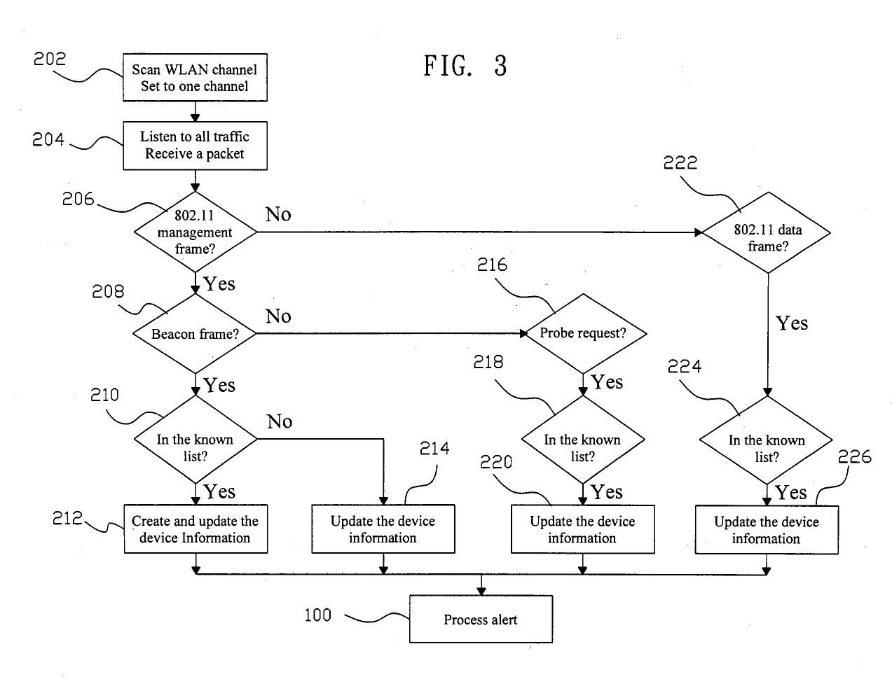

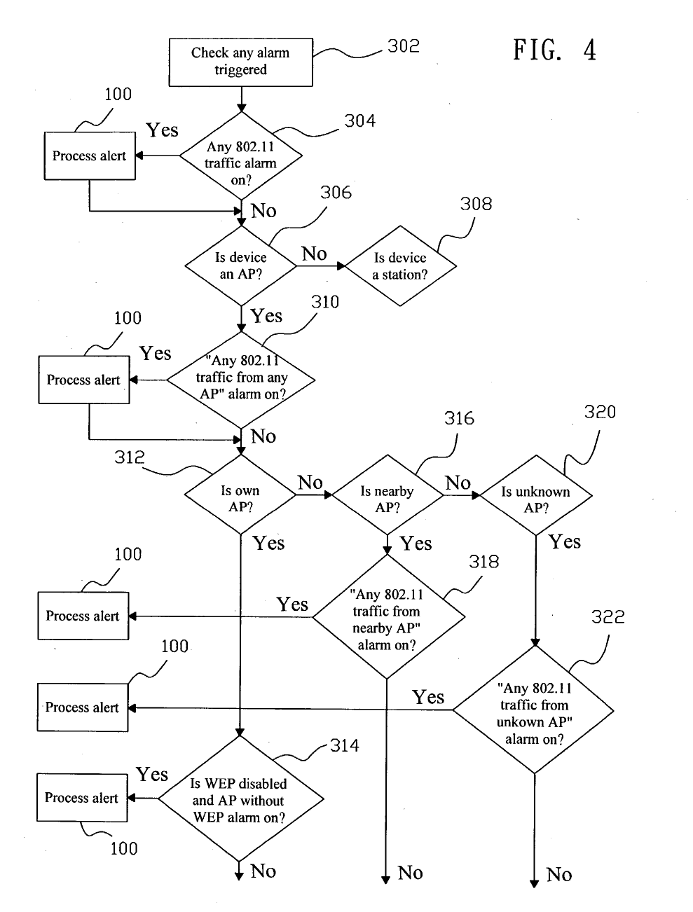

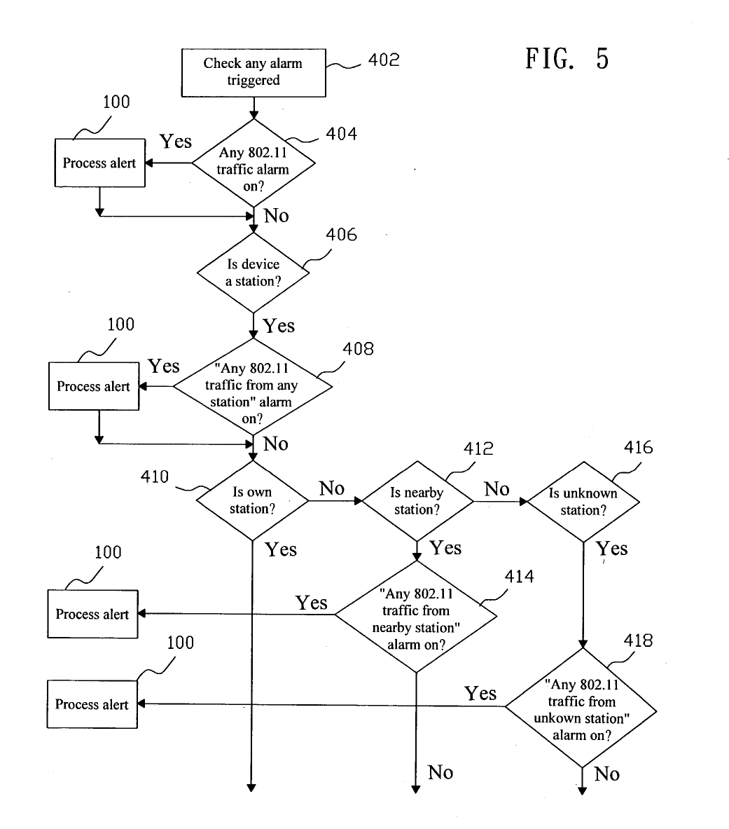

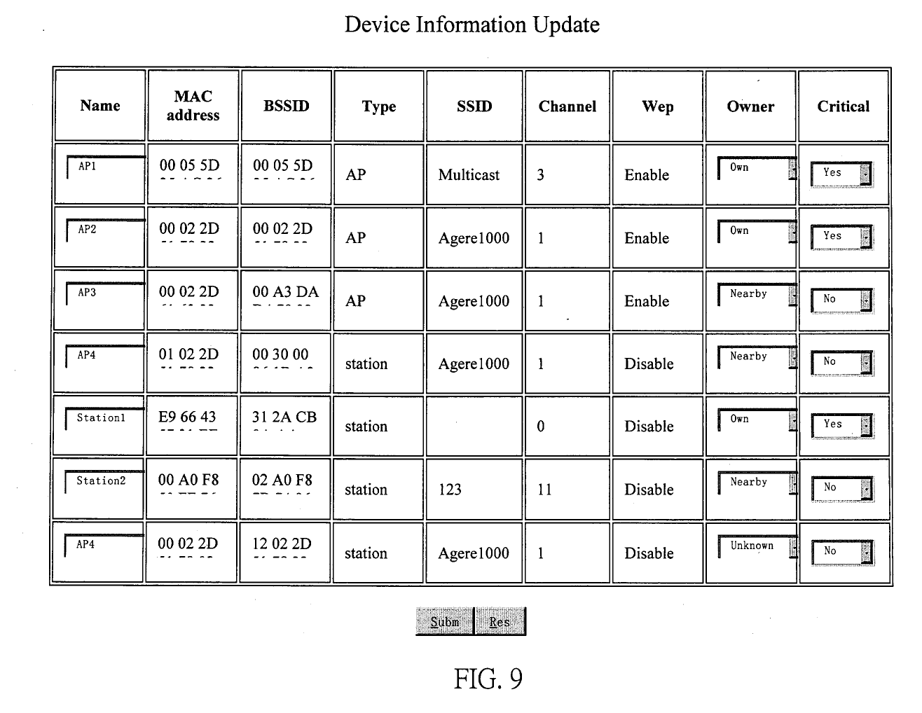

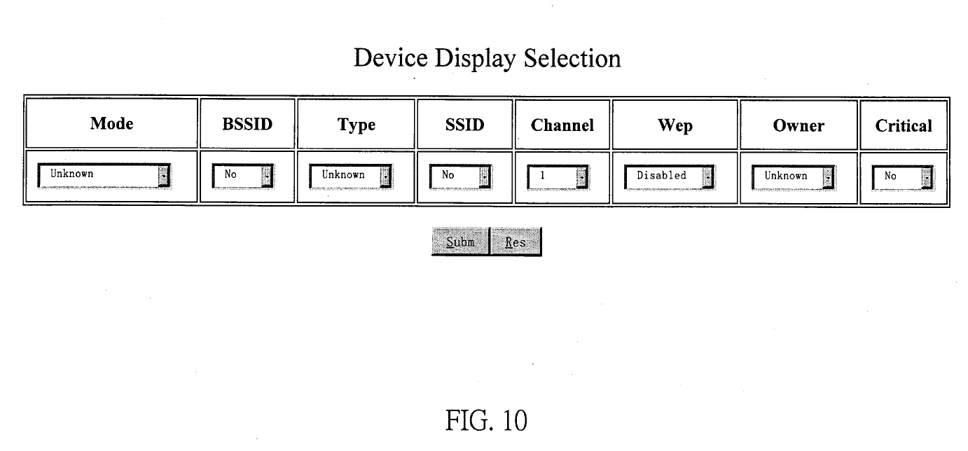

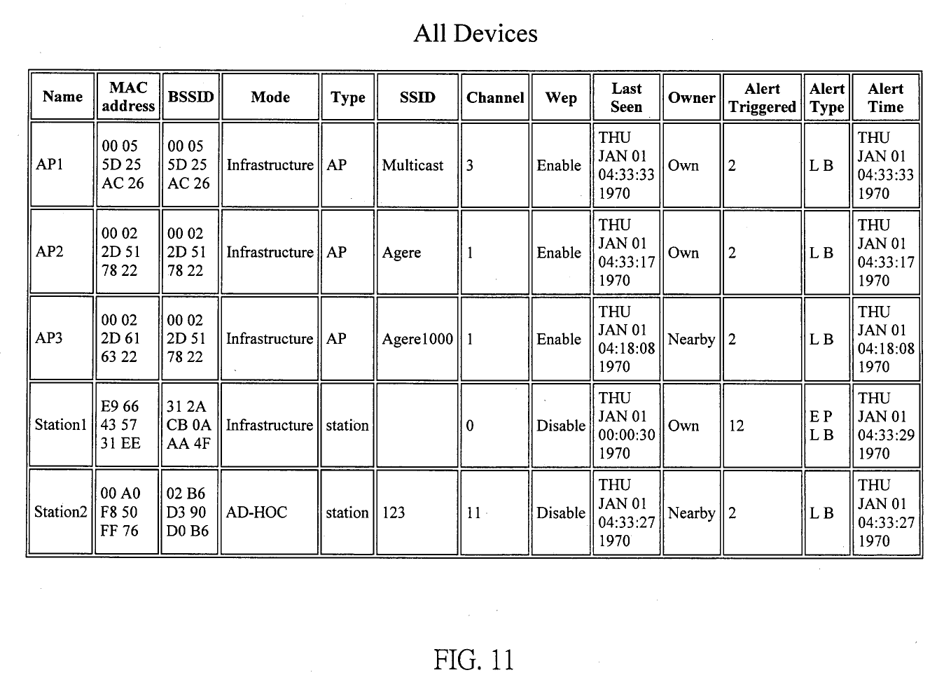

To judge a scanned device or traffic is illegal or not, an embodiment flowchart is provided in FIG. 3. In step 202, the receiver unit scans the WLAN channels and then sets to one of them. As in the typical process, the receiver unit listens to all traffic and receives a packet in step 204. Then a series of steps to check the received packet are performed. In step 206, the packet is checked to identify if it has an 802.11 management frame. If it is, a further check to identify beacon frame is performed in step 208. If the beacon frame is identified, in step 210 the access point will search the known list with the source MAC in the received packet to check the currently scanned device. If it is a known one, the access point will create and update the scanned device information in step 212; otherwise, it updates the scanned device information in step 214. If the beacon frame is not found in the previous step 208, it is checked to identify if probe request is received in step 216. If it is, in step 218 the access point will search the known list with the source MAC in the received packet to check the currently scanned device. If it is a known one, the access point will update the scanned device information in step 220. On the other hand, if no 802.11 management frame is found in the previous step 206, the received packet is further checked in step 222 to identify if an 802.11 data frame is received. If it is, in step 224 the access point will search the known list with the source MAC in the received packet to check the currently scanned device. If it is a known one, the access point will update the scanned device information in step 226. FIG. 9 and FIG. 10 are provided for illustrations of the devices information update and the device selected to be displayed. By repeated updating the devices information that the access point scanned, it learns and collects all wireless devices to build up a table as shown in FIG. 11 for their information. After each condition is checked in this flowchart of FIG. 3, step 100 is performed to check if an alert is needed. During the monitoring of illegal communications, the frequency an illegal wireless device is scanned can be defined to be a parameter to generate alarms. In detail, a threshold is preset up, and then the alarm is triggered only when the frequency an illegal wireless device is scanned reaches the threshold. This manner the sensitivity of the access point is reduced, so that the alarm will not triggered very often. Since the configuration to screen the scanned packets is user-defined, as shown in FIG. 6, how sensitive the access point is to the illegal communications is determined by the user. FIG. 4 and FIG. 5 provide two flowcharts to screen scanned access points and stations, respectively.

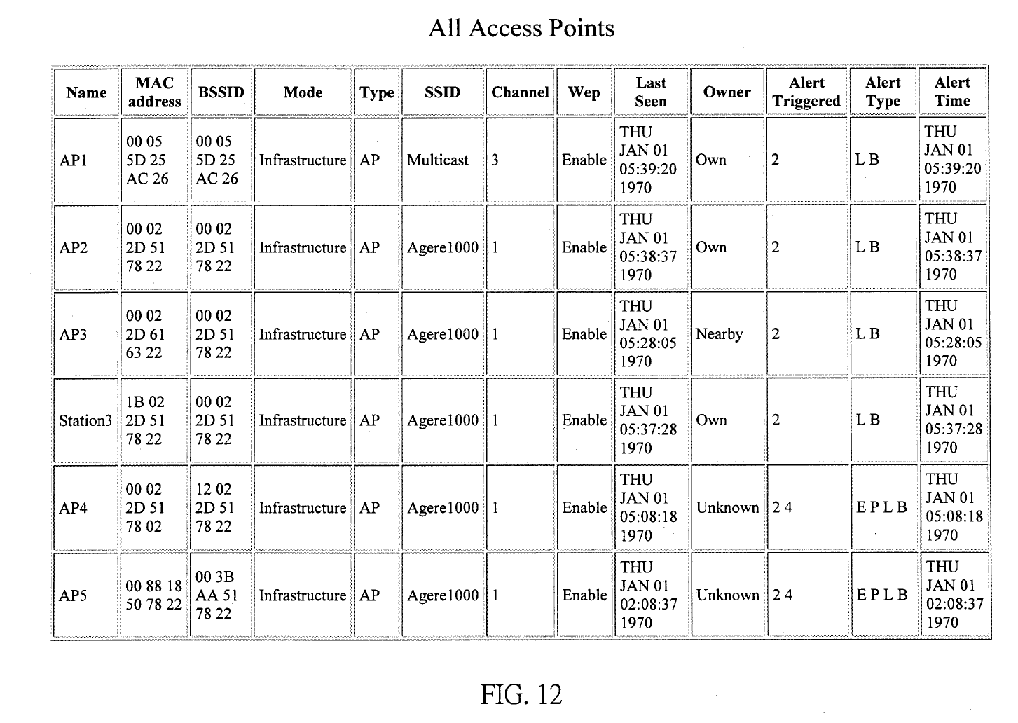

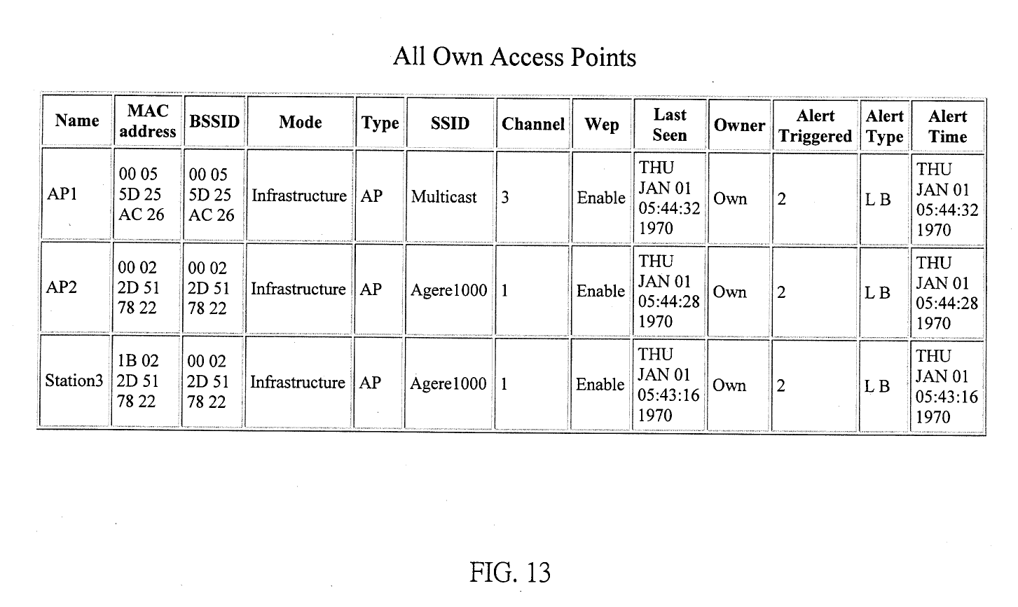

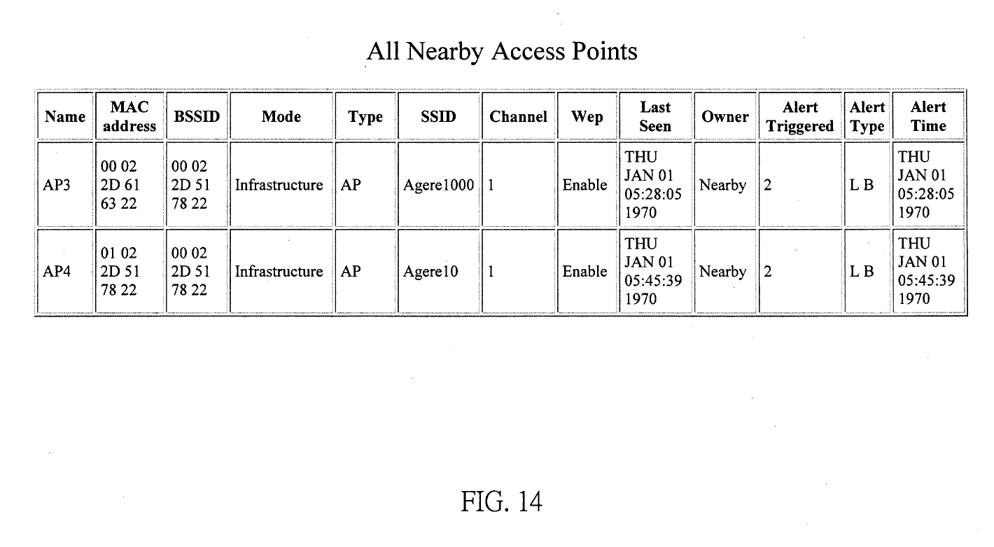

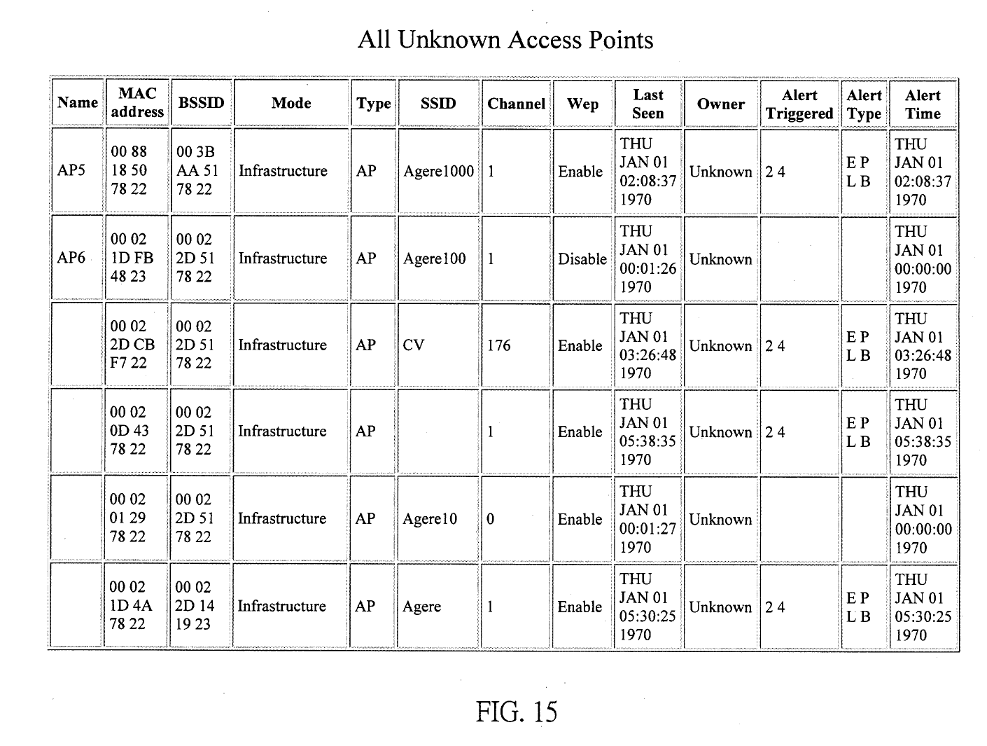

For access points, referring to FIG. 4, step 302 checks if any alarm triggered. In step 304, it is checked if any 802.11 traffic alarm is on. If it is, step 100 is performed to generate one or more alarms as shown in FIG. 2; otherwise, the scanned device is checked if it is an access point in step 306. There is a table such as in FIG. 12 to include all access points that have been registered or scanned. If the scanned device is not an access point, a further check to identify a station is performed in step 308, which is shown more detailed in FIG. 5. In the flowchart of FIG. 4, if the scanned device is an access point, then it checks if any 802.11 traffic from any access point alarm is on. If it is, step 100 is performed to generate one or more alarms; otherwise, the scanned access point is checked to identify it is own access point, as shown in FIG. 13, in step 312, a nearby access point, as shown in FIG. 14, in step 316, or an unknown access point, as shown in FIG. 15, in step 320. If it is own access point, step 314 further checks its WEP function. If it is a nearby access point, step 318 further checks if any 802.11 traffic from any nearby access point alarm is on. If it is an unknown access point, step 322 further checks if any 802.11 traffic from unknown access point alarm is on. If any alarm is triggered in step 314, 318 or 322, step 100 will be performed to generate alarms.

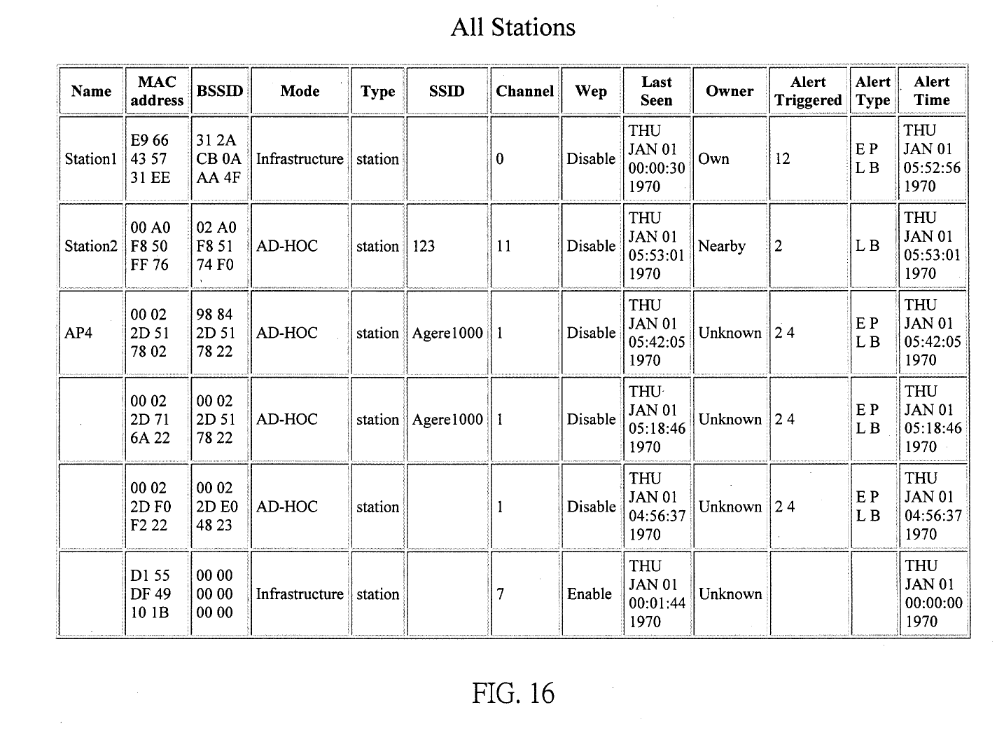

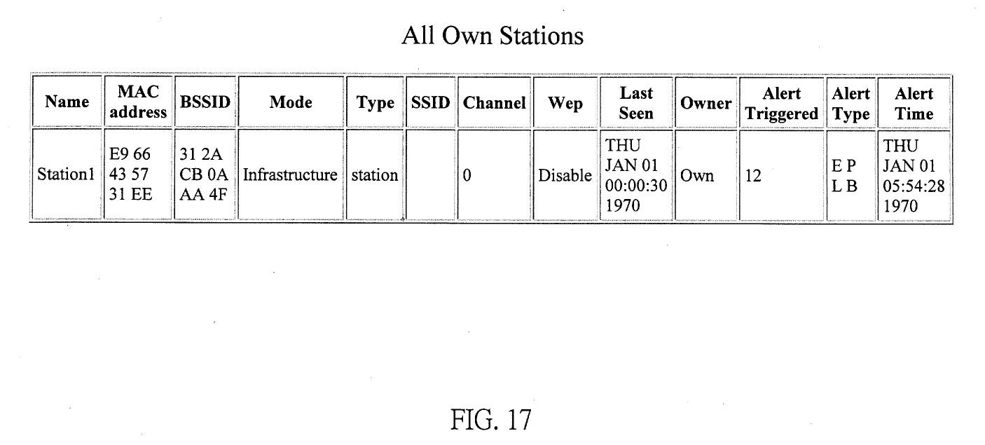

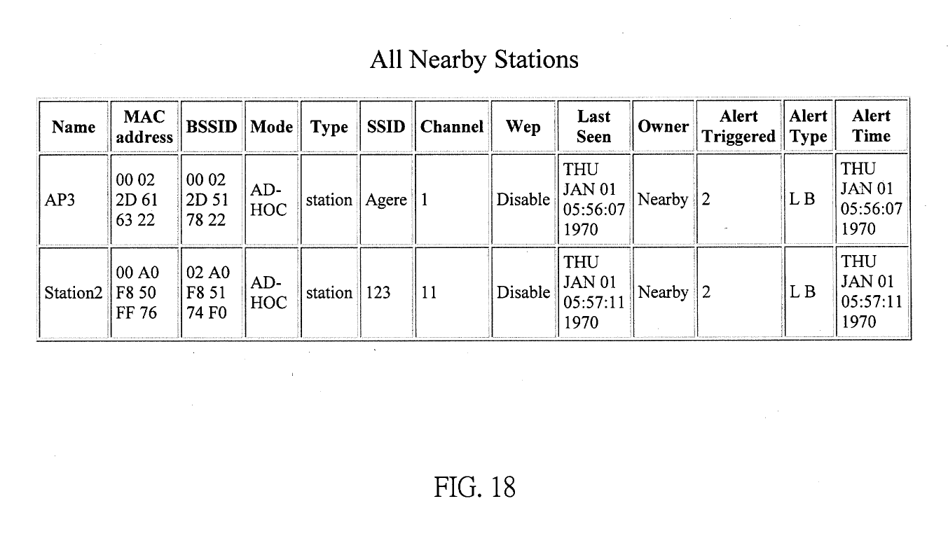

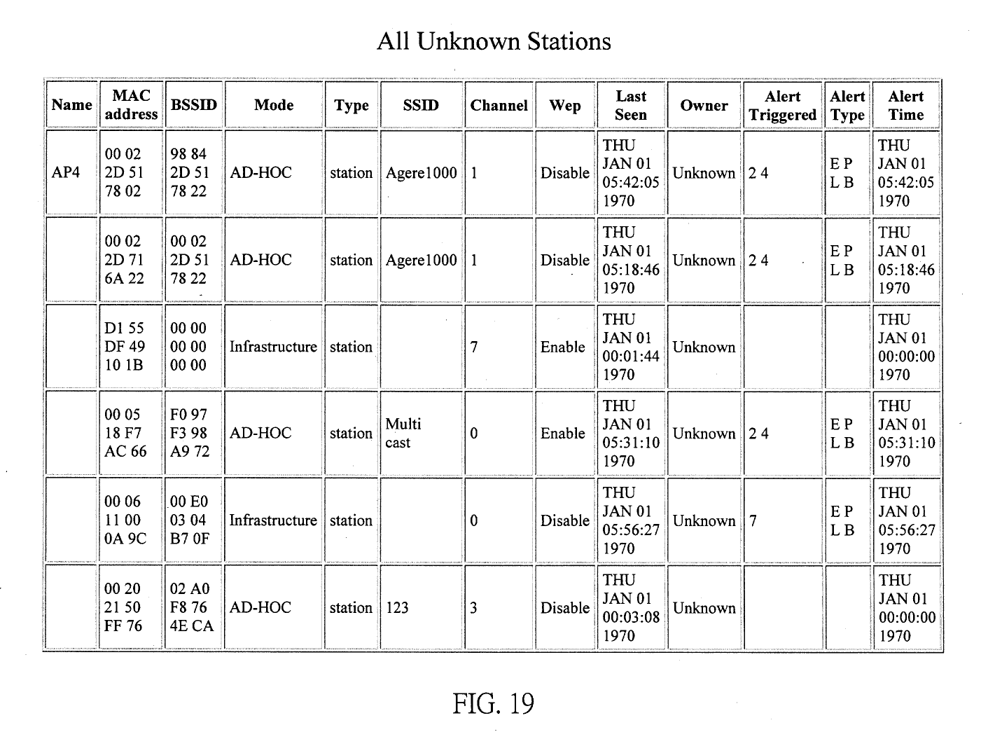

FIG. 5 shows the flowchart to screen the scanned stations to generate alarms. Step 402 checks if any alarm triggered. In step 404, it is checked if any 802.11 traffic alarm is on. If it is, step 100 is performed to generate one or more alarms; otherwise, the scanned device is checked if it is a station in step 406. There is a table such as in FIG. 16 to include all stations that have been registered or scanned. If it is a station, then it checks if any 802.11 traffic from any station alarm is on. If it is, step 100 is performed to generate one or more alarms; otherwise, the scanned station is checked to identify it is own station, as shown in FIG. 17, in step 410, a nearby station, as shown in FIG. 18, in step 412, or an unknown station, as shown in FIG. 19, in step 416. If it is a nearby station, step 414 further checks if any 802.11 traffic from any nearby station alarm is on. If it is an unknown station, step 418 further checks if any 802.11 traffic from unknown station alarm is on. If any alarm is triggered in step 414 or 418, step 100 will be performed to generate alarm.

As illustrated in the above embodiments, by scanning all reached channels and checking the received packets, illegal wireless devices and traffic can be found out by the invented access point, and therefore, early response can be made for harmful situations.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. An access point incorporating a function of monitoring illegal wireless communications, comprising:
a transceiver unit for performing a function of a normal access point;
a receiver unit for scanning a plurality of channels;
a buffer for storing a plurality of scanned packets from said receiver unit to be screened by an algorithm to detect an illegal device or traffic; and
a warning apparatus for representing a detected illegal device or traffic.

2. An access point according to claim 1, wherein said receiver unit comprises:
an RF receiver for transforming an RF signal from said plurality of channels to a baseband signal;
a baseband process receiver for transforming said baseband signal to a decoded signal; and
a MAC receiver for extracting one or more packets from said decoded signal.

3. An access point according to claim 1, wherein said warning apparatus comprises an LED lamp.

4. An access point according to claim 1, wherein said warning apparatus comprises a buzzer.

5. An access point according to claim 1, further comprising means for automatically sending an email alert.

6. An access point according to claim 1 further comprising means for automatically sending a phone alert.

7. An access point according to claim 1, wherein said algorithm compares said plurality of scanned packets with a configuration defining said illegal device or traffic to be alerted by said warning apparatus.

8. A method for monitoring illegal wireless communications for an access point, comprising the steps of:
incorporating a receiver unit in said access point;
scanning a plurality of channels by said receiver unit;
storing a plurality of scanned packets from said receiver unit;
screening said plurality of scanned packets for detecting an illegal device or traffic; and
alerting a detected illegal device or traffic.

9. A method according to claim 8, wherein said scanning a plurality of channels comprises the steps of:
receiving an RF signal;
transforming said RF signal to a baseband signal;
transforming said baseband signal to a decoded signal; and
extracting one or more packets from said decoded signal.

10. A method according to claim 8, wherein said alerting a detected illegal device or traffic comprises blinking an LED lamp.

11. A method according to claim 8, wherein said alerting a detected illegal device or traffic comprises buzzing a buzzer.

12. A method according to claim 8, wherein said alerting a detected illegal device or traffic comprises sending an email alert.

13. A method according to claim 8, wherein said alerting a detected illegal device or traffic comprises sending a phone alert.

14. A method according to claim 8, wherein said screening said plurality of scanned packets comprises comparing said plurality of scanned packets with a configuration defining said illegal device or traffic to be alerted.

15. A method according to claim 14, further comprising updating said configuration.

16. A method according to claim 8, further comprising registering a nearby wireless device to be ignored in said screening said plurality of scanned packets.

17. A method according to claim 8, further comprising determining a frequency that an illegal device is detected for said alerting.
